(19) United States
(12) Patent Application Publication
(10) Pub. No.: US 2015/0277625 A1
(43) Pub. Date: Oct. 1, 2015

(54) INPUT DEVICE AND DISPLAY DEVICE

(71) Applicant: Panasonic Intellectual Property Management Co., Ltd., Osaka (JP)

(72) Inventors: Naoki KOSUGI, Kyoto (JP); Masayuki OYAMADA, Osaka (JP); Takashi KITADA, Osaka (JP); Hiroyuki KADO, Osaka (JP)

(21) Appl. No.: 14/635,076

(22) Filed: Mar. 2, 2015

(30) Foreign Application Priority Data
Mar. 25, 2014 (JP) 2014-061333
Sep. 8, 2014 (JP) 2014-182431

(51) Int. Cl. G06F 3/044

(52) U.S. Cl. CPC G06F 3/044

(57) ABSTRACT

An input device includes a plurality of touch panels and a position calculation unit. Each touch panel detects a touch operation and outputs detection values. The position calculation unit calculates the touch position touched in the touch operation, based on the detection values from the touch panels. The touch panels are joined together via a joint portion. In response to a touch operation of touching a joint region of the joint portion, the position calculation unit calculates the touch position in the joint region based on the detection values in the touch panels adjacent to each other across the touched joint region.

### BACKGROUND

1. Technical Field

The present disclosure relates to an input device that has an input function of receiving a touch operation and a display device provided with the input device.

2. Related Art

Display devices each provided with an input device that has a screen input function for a user to input information by a touch operation on a display screen with a finger or the like have been used in mobile electronic devices such as PDAs and portable terminals, various home appliances, and stationary customer information terminals such as unmanned reception machines. As a touch detection method for the input devices each having an input function of receiving a touch operation, there has been known an electrostatic capacitive coupling method that detects a change in capacitance.

An electrostatic capacitive coupling type touch panel has high transmittance (approximately 90%) so that the touch panel can reduce degradation of display image quality. The electrostatic capacitive coupling type touch panel is further advantageous in terms of durability since the touch panel has electrodes for coordinate detection that do not come into mechanical contact with other electrodes.

With respect to a display device having a touch sensor function such as an electronic board, there has been a demand for a large-sized display device which can be manufactured at a low cost. To satisfy such a demand, the development of a multi display which is constituted by arranging a plurality of small-sized display devices or panels has been progressed.

WO2011/052324 discloses technology where two or more display screens and touch panels located on the display screens respectively. In WO2011/052324, when a predetermined touch operation is carried out upon the two adjacent display screens, a processing unit recognizes that a component in a predetermined region between two touched points has been designated.

JP 2013-45150 A discloses a display device where a plurality of touch panels are arranged such that the touch panels partially overlap with each other.

### SUMMARY

It is an object of the present disclosure to provide an input device in which a plurality of touch panels are joined together and which is capable of detecting a touch position in a region where the plurality of touch panels are joined.

An input device according to the present disclosure includes a plurality of touch panels and a position calculation unit. The touch panels are each configured to detect a touch operation and output detection values. The position calculation unit is configured to calculate a touch position touched in the touch operation, based on the detection values from the touch panels. The touch panels are joined together via a joint portion. The position calculation unit calculates, in response to a touch operation of touching a joint region on the joint portion, the touch position in the joint region based on the detection values in the touch panels adjacent to each other across the touched joint region.

A display device according to the present disclosure includes the input device and a display unit having a display surface configured to display an image.

According to the input device in the present disclosure, it is capable of detecting the touch position in the joint region by using the detection values in the plurality of touch panels adjacent to each other across the joint region.

### BRIEF DESCRIPTION OF DRAWINGS

FIG. 1 is a block diagram for describing an overall configuration of a liquid crystal display device according to the first embodiment.

FIG. 2 is a block diagram illustrating detail configuration of the touch panel according to the first embodiment.

FIG. 3 is a diagram illustrating an example of arrangement of the drive electrodes and the sensing electrodes included in the touch sensor.

FIG. 4A is a diagram of a schematic configuration and an equivalent circuit of the touch sensor with no touch operation.

FIG. 4B is a diagram of a schematic configuration and an equivalent circuit of the touch sensor with a touch operation.

FIG. 5 is a diagram illustrating a change of the detection signal in the case that the touch operation is performed or not performed.

FIG. 6 is a diagram illustrating the array of the scanning signal lines, the array of the drive electrodes and the sensing electrodes.

FIGS. 7A to 7F are diagrams illustrating an example of sequential relationship between input of the scanning signals and supply of the driving signal.

FIG. 8 is a timing chart illustrating a state of application of the scanning signals and the driving signals during one frame period.

FIG. 9 is a timing chart for describing an example of relationship between a display update period and a touch detection period.

FIG. 10 is a diagram for describing detailed positional relationship between the touch panels and the joint portion according to the first embodiment.

FIG. 11 is a diagram illustrating an example of a detection state on the touch panel when the joint portion is touched.

FIG. 12 is a flow chart for a process of calculating a touch position according to the first embodiment.

FIG. 13 is a diagram for describing calculation of the touch position according to the first embodiment.

FIG. 14 is a diagram for describing calculation of the touch position in the case that the touch position is near the joint region.

FIG. 15 is a diagram for describing calculation of the touch position in the case that the touch position is in the joint region.

FIG. 16 is a diagram illustrating an example of arrangement of the virtual electrodes according to the second embodiment.

FIG. 17 is a flow chart for a process of calculating a touch position according to the second embodiment.

FIG. 18 is a diagram for describing calculation of the touch position according to the second embodiment.

### DETAILED DESCRIPTION

Hereinafter, an embodiment is described in detail while referring to the drawings as appropriate. However, detailed descriptions are sometimes omitted when they are not required. For example, detailed descriptions of already well-known matters and repeated descriptions of substantially identical configurations are sometimes omitted. This has been done in order to avoid the following description from becoming unnecessarily redundant, and to facilitate understanding for persons skilled in the art.

It should be noted that the inventor(s) has provided the appended drawings and the following description in order for persons skilled in the art to sufficiently understand the present disclosure, not with the intention of thereby restricting the subject described in the claims.

### First Embodiment

The first embodiment will be described below with reference to the attached drawings.

### 1-1. Configuration

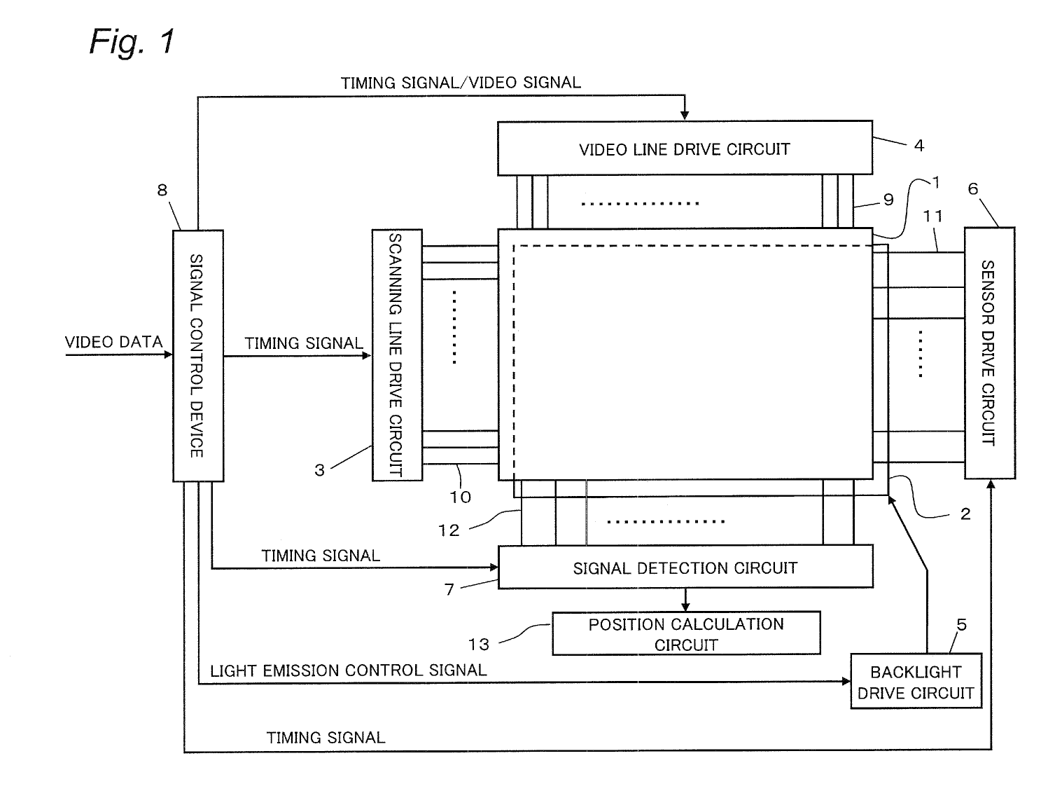

FIG. 1 is a block diagram for describing an overall configuration of a liquid crystal display device provided with a touch sensor which is an input device according to the first embodiment. As illustrated in FIG. 1, the liquid crystal display device includes a display unit 1, a backlight unit 2, a scanning line drive circuit 3, a video line drive circuit 4, a backlight drive circuit 5, a signal control device 8, and a position calculation circuit 13.

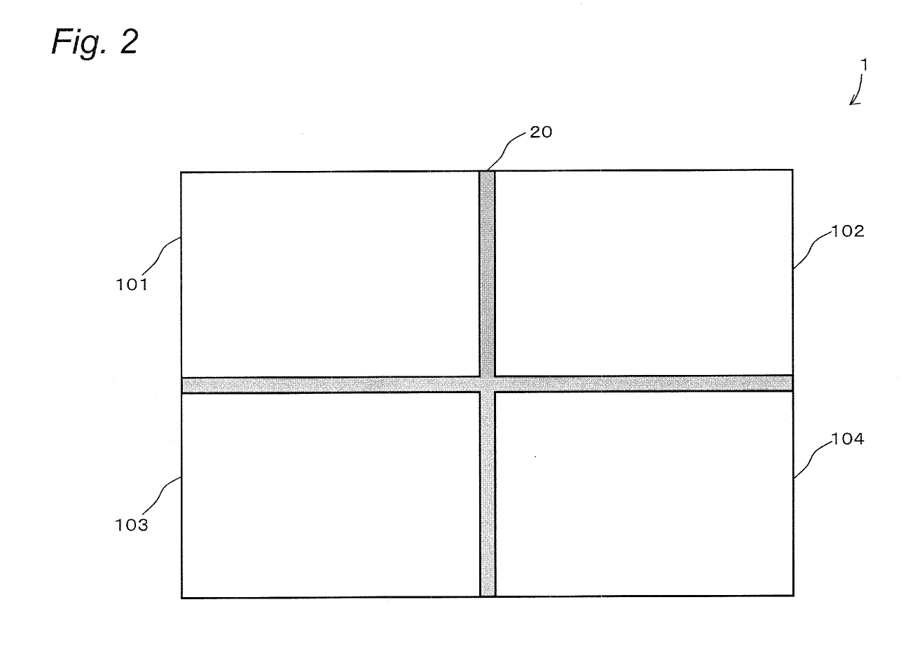

The display unit 1 displays an image and a character on a display surface. The display unit 1 is configured by a plurality of liquid crystal panels. Each liquid crystal panel is a touch panel that has a touch sensor function. As illustrated in FIG. 2, four touch panels 101 to 104 are arranged at predetermined intervals, and constitute the display unit 1 as one panel with each of the touch panels joined at the intervals by a joint portion 20. The joint portion 20 is made of resin, for example. However, the material for the joint portion 20 is not limited to resin, and any material may be used as long as it is visually inconspicuous.

Since the respective touch panels 101 to 104 have the same configuration, the touch panel 101 will be described as an example herein. The touch panel 101 includes a TFT substrate made of a transparent substrate such as a glass substrate and a counter substrate that is arranged opposite to the TFT substrate with a predetermined gap from the TI substrate, and is configured to enclose a liquid crystal material between the TFT substrate and the counter substrate.

The TFT substrate is located on a back side of the display unit 1. Pixel electrodes arrayed in a matrix form, thin film transistors (TFT) provided correspondingly to the pixel electrodes to serve as switching elements for on-off control of voltage application to the pixel electrodes, common electrodes, and the like are formed on a substrate that constitutes the TFT substrate.

The counter substrate is located on a front side of the display unit 1. On a transparent substrate that constitute the counter substrate, there are formed color filters (CF) of at least three primary colors of red (R), green (G), and blue (B) at positions corresponding to the pixel electrodes; a black matrix that is made of a light-shielding material for enhancing contrast and arranged between respective subpixels of RGB and/or between pixels constituted of the subpixels of RGB; and the like. Hereinafter, the present embodiment will be described on the assumption that the TFTs formed on the TFT substrate for the respective subpixels are n-channel TFTs.

On the TFT substrate, a plurality of video signal lines 9 and a plurality of scanning signal lines 10 are formed so that the video signal lines 9 and the scanning signal lines 10 are substantially orthogonal to each other. Each of the scanning signal lines 10 is arranged in a horizontal direction of the TFTs and commonly connected to gate electrodes of the plurality of TFTs. Each of the video signal lines 9 is arranged in a vertical direction of the TFTs and commonly connected to drain electrodes of the plurality of TFTs. The pixel electrodes arranged in pixel regions corresponding to the TFTs are connected to source electrodes of the respective TFTs.

The respective TFTs formed on the TFT substrate are under on-off operation control in predetermined units in response to scanning signals applied to the scanning signal lines 10. The respective TFTs in a horizontal line controlled to be turned on set electric potentials of the pixel electrodes (pixel voltages) according to video signals applied to the video signal lines 9. Therefore, the display unit 1, which has the plurality of pixel electrodes and the common electrodes provided opposed to the pixel electrodes, controls orientation of liquid crystal for each pixel region by using an electric field generated between the pixel electrode and the common electrode to change the transmittance for light entered from the backlight unit 2, so that an image is formed on the display surface.

The backlight unit 2 is arranged on the back side of the display unit 1 and is configured to irradiate light from the back side of the display unit 1. For the backlight unit 2, there have been known a structure in which a plurality of light-emitting diodes are arranged to form a surface light source, and a structure in which a surface light source is constructed to use light irradiated from light-emitting diodes in combination with a light guide plate and a diffuse reflection plate, for example.

The scanning line drive circuit 3 is connected to the plurality of scanning signal lines 10 formed on the TFT substrate. The scanning line drive circuit 3 sequentially selects the scanning signal lines 10 in response to a timing signal input from the signal control device 8, and applies voltage to the selected scanning signal line 10 to turn on the TFT. For example, the scanning line drive circuit 3 includes a shift register. The shift register is activated in response to a trigger signal from the signal control device 8, sequentially selects the scanning signal lines 10 along a vertical scanning direction, and outputs a scanning pulse to the selected scanning signal line 10.

The video line drive circuit 4 is connected to the plurality of video signal lines 9 formed on the TFT substrate. Together with the selection of the scanning signal lines 10 by the scanning line drive circuit 3, the video line drive circuit 4 applies voltage in accordance with the video signal that represents a gradation value of each subpixel to each of the TFTs connected to the selected scanning signal line 10. As a result, the video signals are written in the subpixels corresponding to the selected scanning signal line 10.

The backlight drive circuit 5 causes the backlight unit 2 to emit light at timing and with luminance according to a light emission control signal input from the signal control device 8.

In the present embodiment, an electrostatic capacitive touch sensor is adopted. The touch sensor includes a plurality of drive electrodes 11 and a plurality of sensing electrodes 12. The plurality of drive electrodes 11 and the plurality of sensing electrodes 12 are arranged on the touch panel 101 to cross other. The drive electrodes 11 and the sensing electrodes 12 are examples of the first and second electrodes, respectively.

The touch sensor including the drive electrodes 11 and the sensing electrodes 12 performs response detection in which an input of an electric signal causes a change of electrostatic capacitance between the drive electrodes 11 and the sensing electrodes 12, and detects contact (proximity) of an object to the display surface (detection region). A sensor drive circuit 6 and a signal detection circuit 7 are provided as electric circuits for detecting the contact.

The sensor drive circuit 6, which is a circuit for generating an AC signal, is connected to the drive electrodes 11. For example, the sensor drive circuit 6 receives the timing signal input from the signal control device 8, sequentially selects the drive electrodes 11 in synchronization with image display on the display unit 1, and supplies a driving signal Txv by rectangular pulse voltage to the selected drive electrode 11. For example, the sensor drive circuit 6 includes a shift register similarly to the scanning line drive circuit 3. The shift register is activated in response to a trigger signal from the signal control device 8, sequentially selects the drive electrodes 11 along a vertical scanning direction, and supplies the driving signal Txv by pulse voltage to the selected drive electrode 11.

The drive electrodes 11 and the scanning signal lines 10 extend in the horizontal direction of the TFT substrate (direction of columns), and a plurality of drive electrodes 11 and scanning signal lines 10 are arranged in the vertical direction of the TFT direction (direction of rows). The sensor drive circuit 6 and the scanning line drive circuit 3 electrically connected to the drive electrodes 11 and the scanning signal lines 10 are located on the respective sides in the width direction (the horizontal direction) of a display area where the pixels are arranged, such that the scanning line drive circuit 3 is located on one side in the width direction and the sensor drive circuit 6 is located on the other side in the width direction. Both of the scanning line drive circuit 3 and the sensor drive circuit 6 may be arranged at one side in the width direction of the display area or may be extracted in other directions depending on wiring around the panel.

The signal detection circuit 7 is a circuit for detecting a change of electrostatic capacitance, and is connected to the sensing electrodes 12. The signal detection circuit 7 is provided with a detection circuit with respect to each of the sensing electrodes 12, and outputs the change of electrostatic capacitance detected in the sensing electrodes 12 as a detection signal Rxv. As another configuration example, the signal detection circuit 7 may be provided with one detection circuit for a group of sensing electrodes 12, and may perform detection of the detection signal Rxv for each group of sensing electrodes 12 in a time-sharing manner at a plurality of applications of pulse voltage to the drive electrodes 11.

A position at which an object contacts the display surface is determined based on determination results which one of the drive electrodes 11 the driving signal Txv is applied to and, in that time, which one of the sensing electrodes 12 a signal generated in response to the contact is detected in. An intersection point of the drive electrode 11 to which the driving signal Txv is applied and the sensing electrode 12 from which the detection signal Rxv is received is determined as a contact position as a result of arithmetic operation. The liquid crystal display device may be provided with an arithmetic circuit to perform the arithmetic operation for determining the contact position, or an arithmetic circuit outside the liquid crystal display device may be used for the arithmetic operation.

The signal control device 8 is provided with an arithmetic processing circuit such as a CPU and a memory such as a ROM and a RAM. The signal control device 8 generates an image signal that indicates the gradation value of each subpixel by performing various types of image signal processing including color adjustment based on input video data, and supplies the image signal to the video line drive circuit 4. Further, the signal control device 8 generates timing signals based on the input video data, and supplies the respective timing signals to the scanning line drive circuit 3, the video line drive circuit 4, the backlight drive circuit 5, the sensor drive circuit 6, and the signal detection circuit 7. Furthermore, based on the input video signal, the signal control device 8 supplies a luminance signal for controlling the luminance of the light-emitting diode as a light emission control signal to the backlight drive circuit 5.

A position calculation circuit 13 calculates a touch (contact) position on the display unit 1 by using the detection signal Rxv output from the signal detection circuit 7. Details of a method of calculating the touch position will be described later. The position calculation circuit 13 is an example of the position calculation unit.

In the present embodiment, the scanning line drive circuit 3, the video line drive circuit 4, the sensor drive circuit 6, the signal detection circuit 7, and the position calculation circuit 13, which are connected to the respective signal lines and electrodes of the display unit 1 are configured by semiconductor chips of the respective circuits mounted on a flexible wiring board, a printed circuit board, or a glass substrate. However, each of the scanning line drive circuit 3, the video line drive circuit 4, the sensor drive circuit 6, the signal detection circuit 7, and the position calculation circuit 13 may be formed on the TFT substrate concurrently with the TFTs.

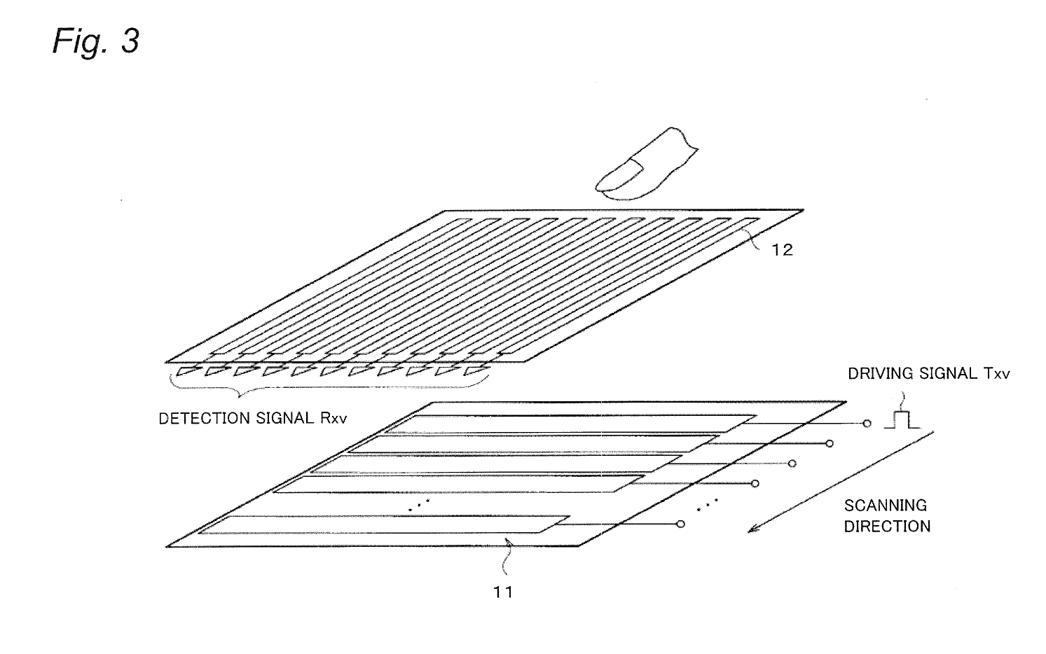

FIG. 3 is a diagram illustrating an example of arrangement of the drive electrodes 11 and the sensing electrodes 12 included in the touch sensor. As illustrated in FIG. 3, the touch sensor as the input device includes the drive electrodes 11 that form an electrode pattern of a plurality of stripes extending in the horizontal direction (a right-left direction in FIG. 2) and the sensing electrodes 12 that are a plurality of electric conductors having stripe forms extending in a direction crossing the extending direction of electric conductors of the drive electrodes 11. A capacitive element having electrostatic capacitance is formed on each intersection of the drive electrodes 11 and the sensing electrodes 12.

The array of the drive electrodes 11 extend in a direction parallel to the direction in which the scanning signal lines 10 extend. Further, on the assumption that M (M is a natural number) scanning signal lines 10 form one line block, the drive electrodes 11 are arranged so that the drive electrodes 11 respectively correspond to N (N is a natural number) line blocks. Details of the arrangement of the drive electrodes 11 will be described later. The drive electrodes 11 apply the driving signal Txv to each of the line blocks.

When a touch detection operation is performed, the driving signal Txv is supplied from the sensor drive circuit 6 to the drive electrodes 11 so as to scan each of the line blocks sequentially in a time-sharing manner. As a result, one line block for the detection target is selected sequentially. Further, since the detection signal Rxv is received from the sensing electrodes 12, touch detection for one line block can be performed.

### 1-2. Operation

### 1-2-1. Principles of Touch Detection

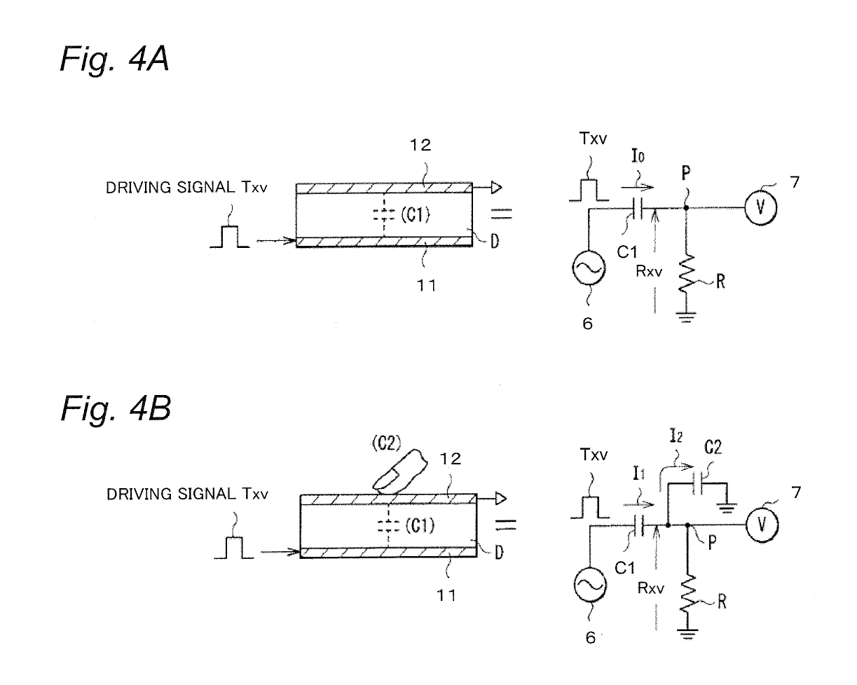

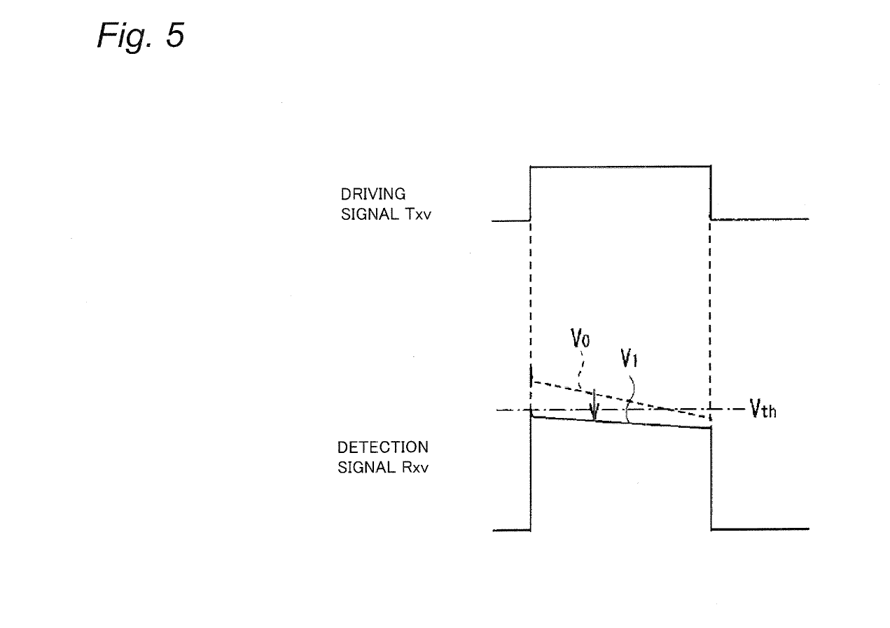

Operation of the liquid crystal display device with the above-described configuration will be described. First, a principle of touch detection of the input device will be described with reference to FIGS. 4A and 4B and FIG. 5. The input device according to the present embodiment adopts a capacitive touch sensor.

FIGS. 4A and 4B are diagrams for describing a schematic configuration and an equivalent circuit of the touch sensor in a state where the touch operation is not performed (FIG. 4A) and in a state where the touch operation is performed (FIG. 4B). FIG. 5 is a diagram illustrating a change of the detection signal in the case as in FIG. 4A or FIG. 4B.

In the electrostatic capacitive touch sensor, a capacitive element is formed on an intersection of a pair of drive electrode 11 and sensing electrode 12 which cross each other (see FIG. 3). Specifically, as illustrated in FIG. 4A, a capacitive element C1 is configured by the drive electrode 11, the sensing electrode 12, and a dielectric body D. One end of the capacitive element C1 is connected to the sensor drive circuit 6 which serves as an AC signal source, and the other end P of the capacitive element C1 is grounded via a resistor R and connected to the signal detection circuit 7 which serves as a voltage detector.

When the driving signal Txv is applied from the sensor drive circuit 6 as the AC signal source to the drive electrode 11 (the one end of the capacitive element C1) by pulse voltage with predetermined frequency around tens kHz to hundreds kHz (see FIG. 5), an output waveform (detection signal) Rxv as illustrated in FIG. 5 is obtained at the sensing electrode 12 (the other end P of the capacitive element C1).

In a state of not in contact with (or not in proximity to) a finger, as illustrated in FIG. 4A, a current I0 in accordance with a capacitance value of the capacitive element C1 flows, accompanying charge and discharge to the capacitive element C1. An electric potential waveform at the other end P of the capacitive element C1 at this time becomes a waveform V0 of the detection signal Rxv illustrated in FIG. 5, and is detected by the signal detection circuit 7 serving as the voltage detector.

On the other hand, in a state of being in contact with (or in proximity to) a finger, as illustrated in FIG. 4B, a capacitive element C2 formed by the finger is added in series with the capacitive element C1 in the configuration of the equivalent circuit. In this state, currents I1 and I2 flow, accompanying charge and discharge to the capacitive element C1 and the capacitive element C2, respectively. An electric potential waveform at the other end P of the capacitive element C1 at this time becomes a waveform V1 of the detection signal Rxv illustrated in FIG. 5, and is detected by the signal detection circuit 7 serving as the voltage detector. In this state, the electric potential at the point P is defined by values of the currents I1 and I2 flowing through the capacitive elements C1 and C2. Therefore, the amplitude of the waveform V1 takes a smaller value than that of the amplitude of the waveform V0 which is obtained in the noncontact state.

The signal detection circuit 7 compares electric potentials of the detection signals Rxv output from the respective sensing electrodes 12 with a predetermined threshold voltage Vth. If the electric potential is equal to or larger than the threshold voltage, the signal detection circuit 7 determines that it is the noncontact state, and if the electric potential is smaller than the threshold voltage, the signal detection circuit 7 determines that it is the contact state. In this manner, the touch detection can be performed. Other methods of sensing a signal indicating a change in electrostatic capacitance include a method of sensing a current.

### 1-2-2. Method of Driving Touch Sensor

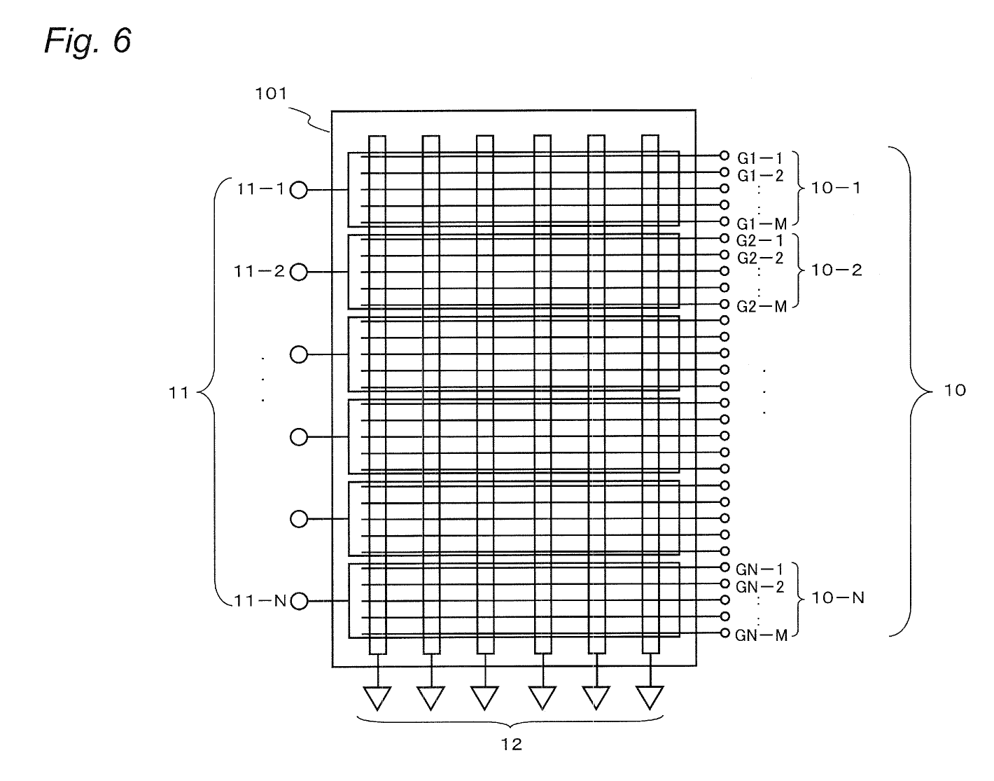

Now, a method of driving the touch sensor in the liquid crystal display device according to the present embodiment will be described with reference to FIG. 6 to FIG. 9.

FIG. 6 is a schematic diagram illustrating the array structure of the scanning signal lines on the liquid crystal panel and the array structure of the drive electrodes and the sensing electrodes in the touch sensor.

X scanning signal lines 10 extending in the horizontal direction are divided into groups each having M (M is a natural number) scanning signal lines Gi-1, Gi-2 . . . Gi-M (i is 1 to N) as illustrated in FIG. 6. Each group is managed as one line block. That is, the scanning signal lines 10 are divided into N (N is a natural number) line blocks 10-1, 10-2 . . . 10-N and arrayed.

The drive electrodes 11 of the touch sensor are arrayed so that N drive electrodes 11-1, 11-2 . . . 11-N extend in the horizontal direction correspondingly to the line blocks 10-1, 10-2 . . . 10-N. The plurality of sensing electrodes 12 are arrayed so that the sensing electrodes 12 cross the N drive electrodes 11-1, 11-2 . . . 11-N.

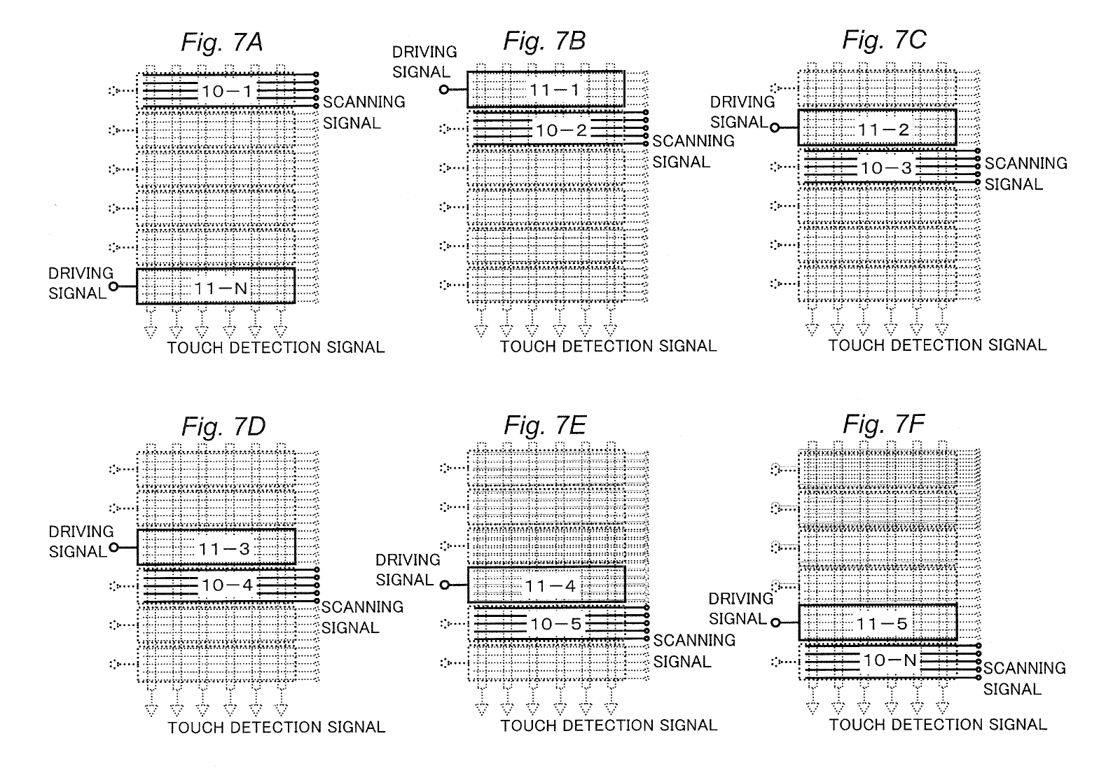

FIGS. 7A to 7F are explanatory diagrams each illustrating an example of relationship between input of the scanning signals to the line block of the scanning signal lines for performing the display update on the liquid crystal panel and supply of the driving signal to the line block of the drive electrodes for performing the touch detection on the touch sensor. FIGS. 7A to 7F each illustrate a state during one line block scanning period. In the present embodiment, the line block of the scanning signal lines to which the scanning signals for performing the display update on the liquid crystal panel are supplied differs from the line block of the drive electrodes to which the driving signal for performing the touch detection on the touch sensor is supplied.

Specifically, as illustrated in FIG. 7A, during a horizontal scanning period in which the scanning signals are sequentially being input to the respective scanning signal lines of the first line block 10-1, the driving signal is supplied to the drive electrode 11-N corresponding to the last line block 10-N. During the subsequent horizontal scanning period, as illustrated in FIG. 7B, the scanning signals are sequentially being input to the respective scanning signal lines of the second line block 10-2 and, also during the same horizontal scanning period, the driving signal is supplied to the drive electrode 11-1 corresponding to the first line block 10-1. During the subsequent horizontal scanning period, as illustrated in FIG. 7C, the scanning signals are sequentially being input to the respective scanning signal lines of the third line block 10. Also during the same horizontal scanning period, the driving signal is supplied to the drive electrode 11-2 corresponding to the second line block 10-2.

In the same manner, as illustrated in FIGS. 7D to 7F, the scanning signals are sequentially input to the respective scanning signal lines of the respective line blocks while the line blocks 10-4, 10-5 . . . 10-N are sequentially switched. At the same time, the driving signal is supplied to the drive electrodes 11-3, 11-4, 11-5 corresponding to the line blocks 10-3, 10-4, 10-5, which are preceding line blocks of the line blocks 10-4, 10-5 . . . 10-N to which the scanning signals are supplied.

That is, the liquid crystal display device according to the present embodiment is configured to supply the driving signal to the drive electrodes 11 by selecting the drive electrode 11-i (i=1 to N) corresponding to the line block to which the scanning signals are not applied for the plurality of scanning signal lines during each line block scanning period for performing the display update.

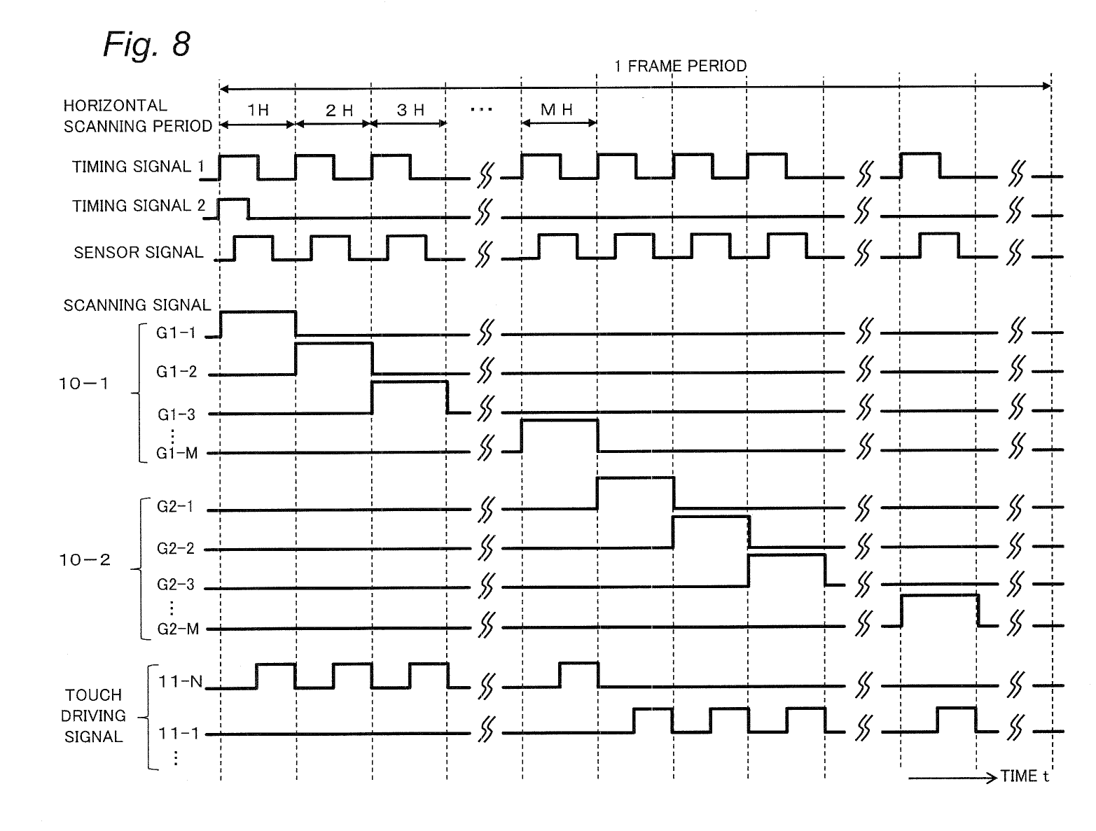

FIG. 8 is a timing chart illustrating a state of application of the scanning signals and the driving signals in the examples illustrated in FIGS. 7A to 7F. FIG. 8 is the timing chart illustrating the touch detection operation in the driving method according to the present embodiment.

As illustrated in FIG. 8, during each of the horizontal scanning periods (1 H, 2 H, 3 H, . . . , MH) of one frame period, the liquid crystal display device performs the display update by inputting the scanning signals to the scanning signal lines 10 for each of the line blocks (10-1, 10-2, . . . , 10-N). During the period in which the scanning signals are input to the scanning signal lines 10, the driving signal for performing the touch detection is supplied to the drive electrodes 11-N, 11-1, 11-2, . . . corresponding to the line block to which the scanning signals are not supplied.

The timing signal is generated by the signal control device 8 for the operation of the display unit 1. In FIG. 8, a timing signal 1 is a signal indicating timing of the scanning signal, and a timing signal 2 is a signal indicating timing to start scanning. FIG. 8 illustrates the example where the scanning starts at the line block 10-1. Specifically, when the timing signal 1 is input after input of the timing signal 2, an operation of inputting the scanning signal to the scanning signal line G1-1 starts.

The liquid crystal di splay device may be provided with a sensor control circuit (not illustrated) which is configured to generate a sensor signal in response to the timing signals input from the signal control device 8, and to control the sensor drive circuit 6 and the signal detection circuit 7 based on the sensor signal. The sensor signal is a signal generated for sensor operation. The sensor control circuit generates the sensor signals with a predetermined delay based on the timing signals 1 and 2 input from the signal control device 8. The sensor drive circuit 6 supplies the driving signal to the drive electrodes 11 based on the sensor signals generated by the sensor control circuit. As illustrated in FIG. 8, the sensor signals synchronize with the scanning signals.

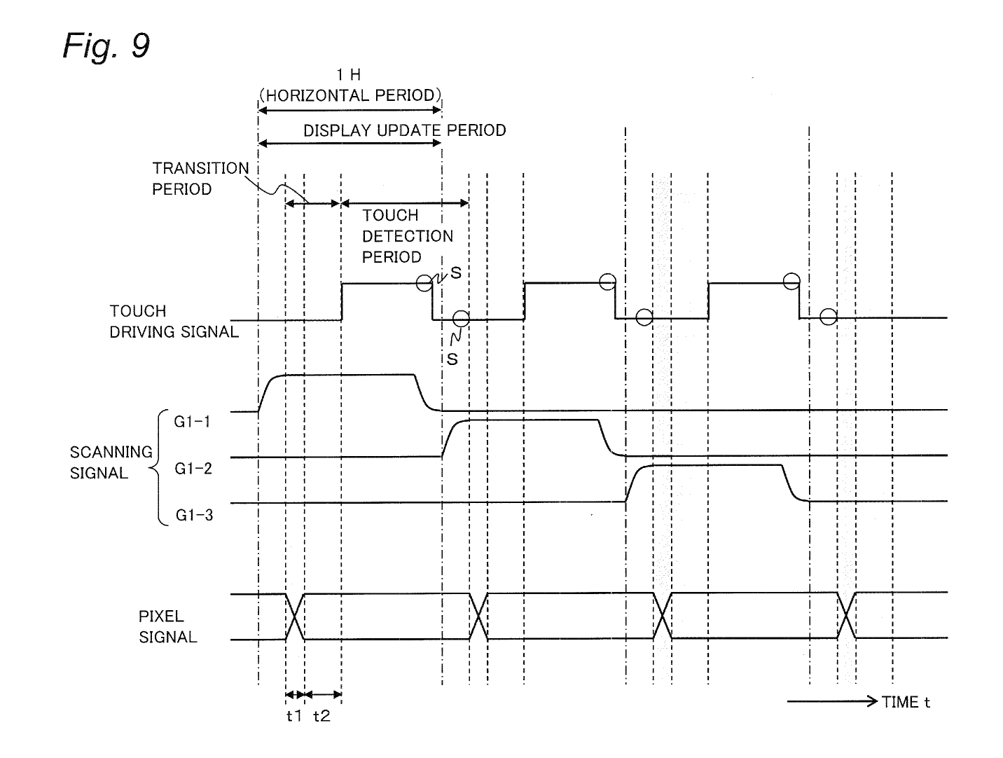

FIG. 9 is a timing chart for describing an example of relationship between a display update period and a touch detection period in one horizontal scanning period.

As illustrated in FIG. 9, during each display update period, scanning signals are input to the scanning signal lines 10 (G1-1, G1-2, . . . ), and pixel signals according to the input video signals are input to the video signal lines 9 which are connected to switching elements of the pixel electrodes of the respective pixels.

In the present disclosure, the touch detection period is provided in synchronized timing with the above-described display update period. The touch detection period is set as a period that follows transition period after the start of the display update period. Specifically, when voltage displacement of the scanning signal rising to a predetermined electric potential has converged (stabilized), the liquid crystal display device supplies a pulse voltage to the drive electrodes 11 as the driving signal to start the touch detection period at the point of displacement of an electric potential of the driving signal caused by rising of the pulse voltage. Further, touch detection timing S is set at two points that are a point immediately before a falling edge of the pulse voltage and a touch detection period end point. Here, the transition period is set as a period including a first-half period t1 in which pixel signals are displaced and a period t2 in which an electric potential of the common electrodes changes to an electric potential of new pixel signals as a result of the displacement of the pixel signals. The above setting is intended to prevent fluctuations in the electric potential of the common electrodes, which is caused by capacitive coupling of parasitic capacitance in the panel after the transition period of the pixel signals, from taking place during the touch detection period.

Touch detection operation during the touch detection period has been described with reference to FIGS. 3 and 4.

Although the touch detection timing S has been described as an example in the present embodiment, the touch detection timing may be other points of time. For example, the touch detection may be performed at a point of time at which a noise is not made by the liquid crystal display device.

In the description made with reference to FIG. 1 and FIGS. 7A to 9, it is assumed that in-cell touch panels are used in the liquid crystal display device. However, the touch panels of the present disclosure do not need to be the in-cell touch panels and may be out-cell touch panels or on-cell touch panels. In the out-cell touch panel or the on-cell touch panel, the scanning line drive circuit and the sensor drive circuit do not need to synchronize with each other.

### 1-2-3. Method of Detecting Touch Position

The liquid crystal display device according to the present embodiment receives an input operation performed by a user's touch operation on the display surface. The position calculation circuit 13 illustrated in FIG. 1 calculates a touch position on the display surface in response to the user's touch operation. First, there will be described a method in which the position calculation circuit 13 senses that the touch panels 101 to 104 or the joint portion 20 in the display surface is touched.

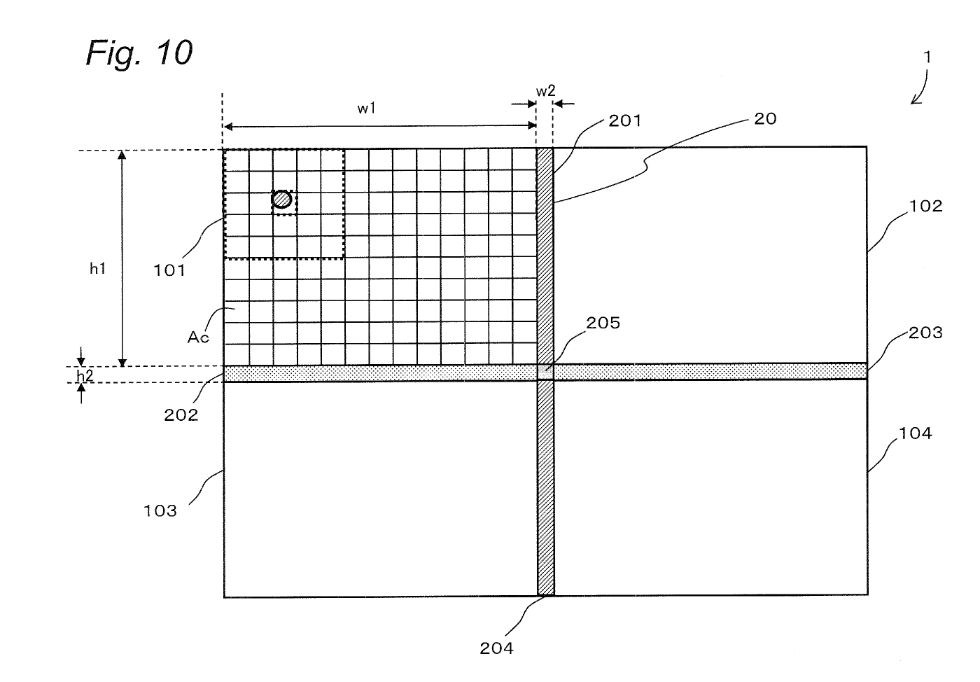

FIG. 10 is a diagram for describing detailed positional relationship between the touch panels 101 to 104 and the joint portion 20 in the display unit 1. In the display unit 1, the joint portion 20 is made of materials such as resin filled in gaps between the adjacent touch panels 101 to 104. For convenience of explanation, the surface region of the joint portion 20 is divided into a plurality of joint regions 201 to 205 in the following description.

As illustrated in FIG. 10, each of the touch panels 101 to 104 has a shape of rectangular flat plate having width w1 and height h1. The touch panel 101 and the touch panel 102 are joined together via a joint region 201 having width w2 and the height h1. Similarly, the touch panel 101 and the touch panel 103 are joined together via a joint region 202 having the width w1 and height h2. The touch panel 102 and the touch panel 104 are joined together via the joint region 203 having the width w1 and the height h2. The touch panel 103 and the touch panel 104 are joined together via the joint region 204 having the width w2 and the height h1. Further, the respective joint regions 201 to 204 are connected together via the joint region 205 having the width w2 and the height h2.

The position calculation circuit 13 detects a user's touch operation based on variation of electrostatic capacitance in the respective touch panels 101 to 104. A detection value indicating the variation of electrostatic capacitance is detected for each of divisions Ac into which each screen (detection region) of the touch panels 101 to 104 is divided in a matrix form. The division Ac of the touch panels 101 to 104 is defined by the drive electrode 11 and the sensing electrode 12 which cross each other (see FIG. 3).

In the case that a touched region by the user is a region on the touch panels 101 to 104, the detection value for the division that includes the touch position changes most greatly from a reference value. Then, the position calculation circuit 13 detects the touch position based on the change in the detection value.

On the other hand, in the case that a touched region by the user is a region on the joint regions 201 to 205 of the joint portion 20, the variation of electrostatic capacitance is not detected in the touch position. Thus, in the present embodiment, a touch position within the joint regions 201 to 205 is detected by using the detection values in divisions adjoining the touched one of the joint regions 201 to 205.

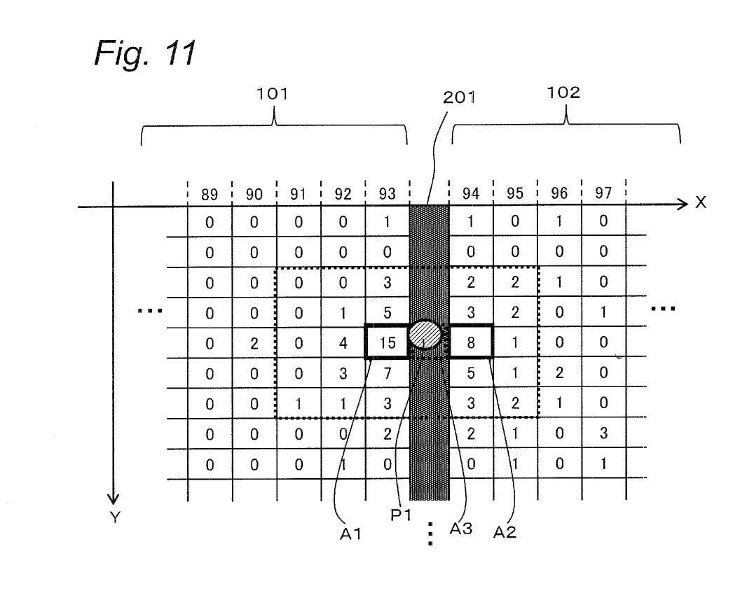

A method in which the position calculation circuit 13 senses that the joint portion 20 is touched will be described with reference to FIG. 11. FIG. 11 is a diagram illustrating an example of a detection state on the touch panel in the case that the joint portion 20 is touched. FIG. 11 shows an example of a state in which the variation of electrostatic capacitance is detected over the touch panel 101 and the touch panel 102 in the case that a point P1 on the joint region 201 is touched. In FIG. 11, a numerical value in each division within a range x≦93 in the x axis indicates the detection value detected in each division on the touch panel 101, and a numerical value in each division within a range x≧94 indicates the detection value detected in each division on the touch panel 102. It is assumed that the reference value for the detection value is 0.

The joint region 201 is an insensible zone in which electrostatic capacitance is not detected, and therefore, in the case that the point P1 on the joint region 201 is touched by the user, the touch is not detected at the point P1. However, in divisions adjoining the touched point P1 on the touch panels 101 and 102 located on both sides of the joint region 201, the detection values change as a result of the variation of electrostatic capacitance caused by proximity of the object that touches the point P1. In the example illustrated in FIG. 11, the detection values detected in the divisions A1 and A2 located on both sides of the point P1 and in divisions in an area around the divisions A1 and A2 have changed. In the case that the detection values in divisions in an area spanning over two touch panels have changed greatest among the detection values in the respective divisions on the touch panels 101 to 104, the position calculation circuit 13 senses that the joint region between the two touch panels is touched. For example, in the case of FIG. 11, since the detection values in the divisions A1 and A2 have changed greatest, the position calculation circuit 13 senses that a joint region A3 between the divisions A1 and A2 has been touched.

When the position calculation circuit 13 according to the present embodiment senses that the touch panels 101 to 104 or the joint portion 20 is touched, the position calculation circuit 13 calculates a detailed touch position in the touched joint region by using the detection values in the touched region and the detection values in the area around the region. A process of calculating the touch position according to the present embodiment will be described below.

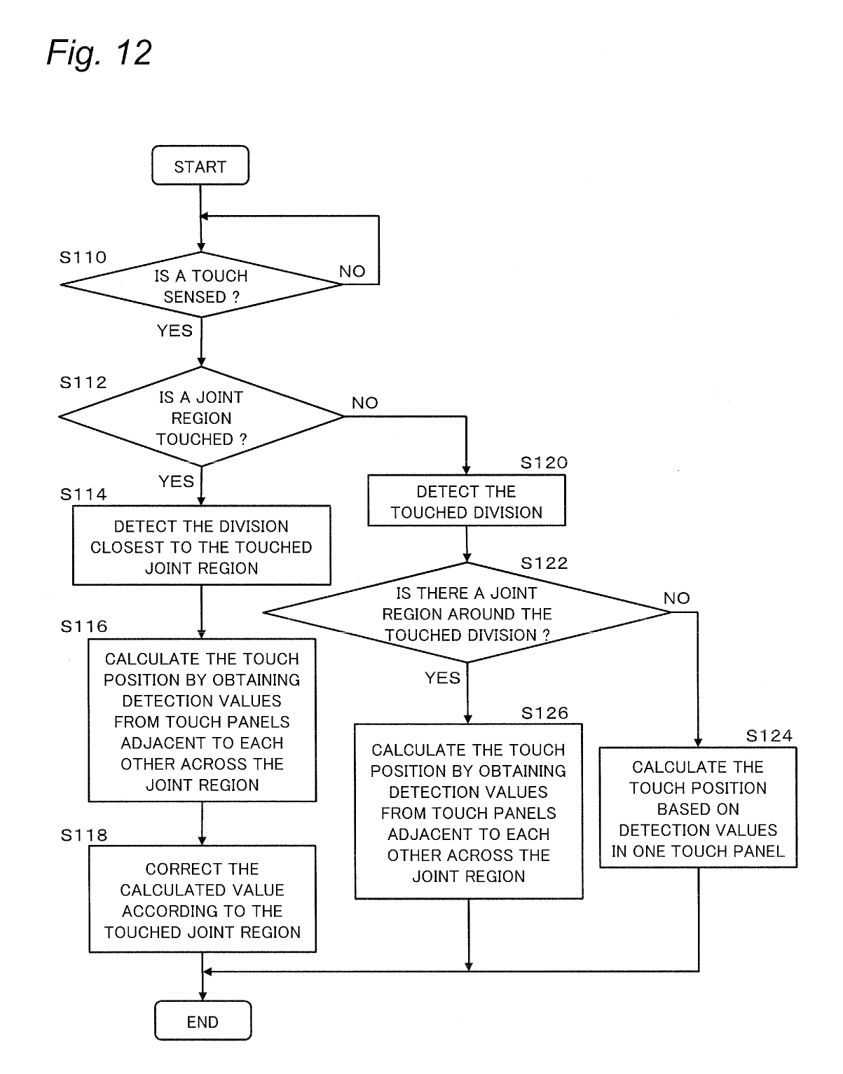

FIG. 12 is a flow chart for a process of calculating a touch position in the liquid crystal display device according to the first embodiment. The flow is executed by the position calculation circuit 13.

First, the position calculation circuit 13 senses whether a touch operation is performed on the display unit 1 (S110). The position calculation circuit 13 performs the touch operation sensing by determining whether a detection value larger than the reference value is detected in any division on the respective touch panels 101 to 104.

When the position calculation circuit 13 senses a touch operation (YES in S110), the position calculation circuit 13 determines whether any of the joint regions 201 to 205 is touched in the sensed touch operation (S112). Specifically, in the case that the division having the largest detection value among the detection values in the divisions on the touch panels 101 to 104 adjoins the joint portion 20 and the division having the next largest detection value adjoins the division having the largest detection value across the joint portion 20, the position calculation circuit 13 senses that the joint region between these divisions is touched.

When the touched region is not any of the joint regions 201 to 205 (N in S112), the position calculation circuit 13 detects a division touched on the touch panels 101 to 104 (S120). The position calculation circuit 13 detects, as the touched division, a division having the largest detection value among the detection values in the divisions on all the touch panels 101 to 104. In the present embodiment, the position calculation circuit 13 calculates the touch position by using different methods depending on positional relationship between the touch position and the joint region as described later.

When there is not any of the joint regions 201 to 205 around the touched division (NO in S122), the position calculation circuit 13 calculates the touch position based on the detection values in one touch panel that includes the touched division (S124). The position calculation circuit 13 determines whether any of the joint regions 201 to 205 is around the touched division, for example, by determining whether a region of 5 rows×5 columns with its center as the touched division overlaps the joint regions 201 to 205. A method of calculating the touch position based on the detection values in one touch panel will be described later.

On the other hand, when there is the joint region around the touched division (YES in S122), the position calculation circuit 13 obtains the detection values from the plurality of touch panels adjacent to each other across the joint region, and calculates the touch position by using the obtained detection values (S126). A method of calculating the touch position by obtaining the detection values from the plurality of touch panels adjacent to each other across the joint region will be described later.

On the other hand, when the touched region is the joint region (YES in S112), the position calculation circuit 13 first detects the division having the largest detection value among the divisions adjoining the touched joint region as the division closest to the touched joint region (S114). Next, the position calculation circuit 13 calculates the touch position by obtaining the detection values from the touch panels adjacent to each other across the joint region in the same manner as the process in step S126 (S116). Further, the position calculation circuit 13 corrects the calculated value according to the touched one of the joint regions 201 to 205 (S118). Details of the operations will be described later.

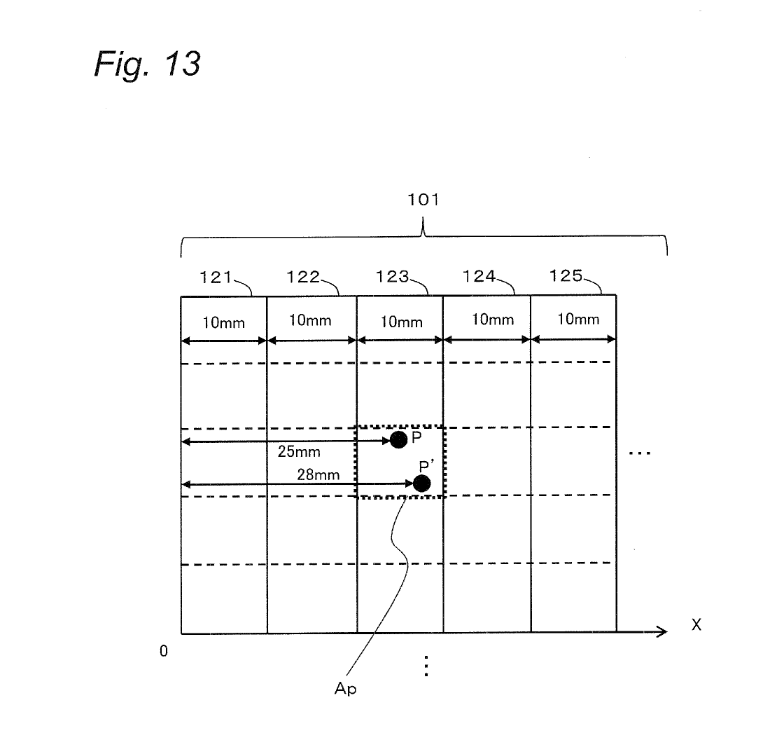

The operation of calculating the touch position in the case that the region of the touch panels is touched in the process in step S124 will be described in detail below. FIG. 13 is a diagram for describing calculation of the touch position in the case that the touch panel 101 is touched. FIG. 13 illustrates a case where the left end part of the touch panel 101 illustrated in FIG. 10 is touched. In FIG. 13, electrode patterns 121 to 125 with a pitch of 10 mm are arranged as the sensing electrodes 12 of the touch panel 101. The dimension of the sensing electrodes 12 is not limited thereto.

As illustrated in FIG. 13, when a point P on the electrode pattern 123 is touched, a touched division Ap is detected (S120). The position calculation circuit 13 calculates coordinates (xt, yt) of the point P by calculating a centroid of a first predetermined region including the touched division Ap and divisions around the touched division Ap by using the detection values in the first predetermined region (S124). In the present embodiment, the detection values in the respective divisions in 5 rows×5 columns around the division Ap (first predetermined region) are used in the centroid calculation. In the centroid calculation, for example, the respective detection values are weighted by the center coordinates of the respective divisions, and a mean value in the divisions of 5 rows×5 columns is calculated. In the centroid calculation, an x-coordinate xt and a y-coordinate yt are calculated according to the following equations by using the detection values Dᵢⱼ in the divisions of 5 rows×5 columns, x-coordinates xᵢ of the respective columns, and y-coordinates yⱼ of the respective rows (i, j=1 to 5).

xt=Σ_{i,j}(Dᵢⱼ×xᵢ)/Σ_{i,j}Dᵢⱼ, (i, j=1 to 5) (1)

yt=Σ_{i,j}(Dᵢⱼ×yⱼ)/Σ_{i,j}Dᵢⱼ, (i, j=1 to 5) (2)

As a result of the centroid calculation by the position calculation circuit 13, the position of the point P inside the division Ap is obtained. For example, in the case that the point P near the center of the electrode pattern 123 is touched, x-coordinate xt=25 the center of the division Ap is obtained. In the case that the point P to the right of the electrode pattern 123 is touched, x-coordinate xt=28 inside the division Ap is obtained.

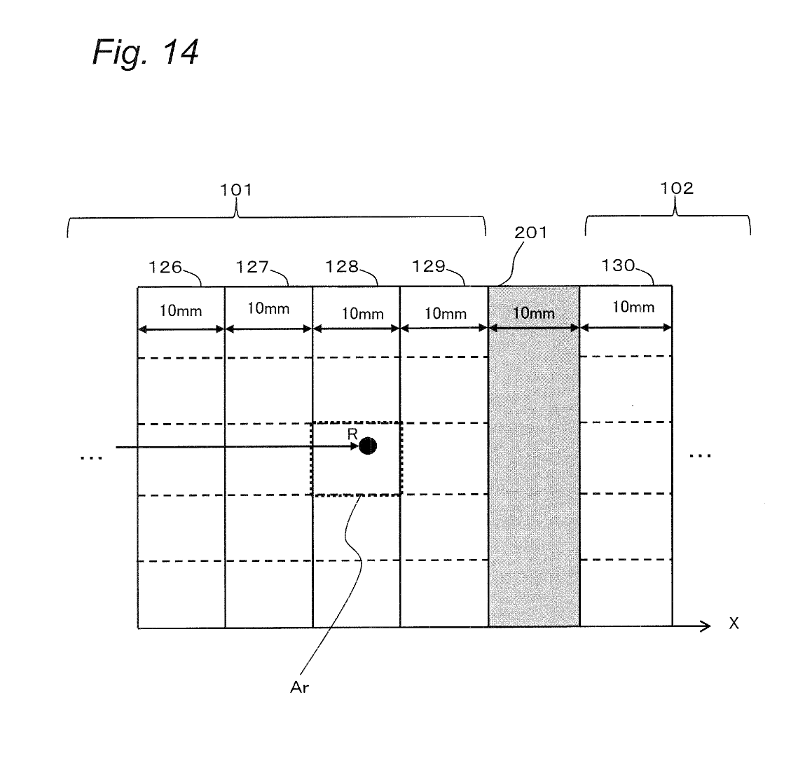

On the other hand, when the joint region is around the division detected in the process of step S120 (YES in S122), the position calculation circuit 13 calculates the touch position by obtaining the detection values from the plurality of touch panels adjacent to each other across the joint region (S126). The processes will be described below with reference to FIG. 14.

As illustrated in FIG. 14, when a point R near the joint region 201 is touched, the joint region 201 is included in an area around a touched division Ar. Therefore, a region of 5 rows×5 columns around the division Ar is not entirely included within the touch panel 101. Then, in order to calculate the position of the point R, the position calculation circuit 13 uses not only the detection values in the area around the division Ar but also the detection values in the touch panel 102 which is adjacent to the touch panel 101 across the joint region 201. Specifically, the position calculation circuit 13 performs the centroid calculation based on the equations (1) and (2) by using the detection values in a region of 5 rows×5 columns around the division Ar in the electrode patterns 126 to 129 of the touch panel 101 and the electrode pattern 130 of the touch panel 102. In the above calculation of the touch position, taking into account decrease of the detection values caused by the span of the region around the division Ar across the joint portion 20, the position calculation circuit 13 may amplify the detection values in the region spanning across the joint region 210 on the electrode pattern 130.

Also, when the touch panel 103 is touched, the position calculation circuit 13 calculates the x-coordinates in the same manner as in the case that the touch panel 101 is touched. When the touch panel 102 or 104 is touched, the position calculation circuit 13 computes the x-coordinates in the same manner as in the case of the touch panel 101, and calculates the x-coordinates by adding the width w1 of the touch panel 101 or 103 and the width w2 of the joint region 201 or 204 to the computed values.

As for the y-coordinates, the position calculation circuit 13 executes the same calculation as the above-described calculation of the x-coordinates. The position calculation circuit 13 obtains, as the y-coordinates, the computed values of the centroid calculation for the touch position on the touch panel 101 or 102. For the touch position on the touch panel 103 or 104, the position calculation circuit 13 calculates the y-coordinates by adding the height h1 of the touch panel 101 or 102 and the height h2 of the joint region 202 or 203 to the computed values of the centroid calculation.

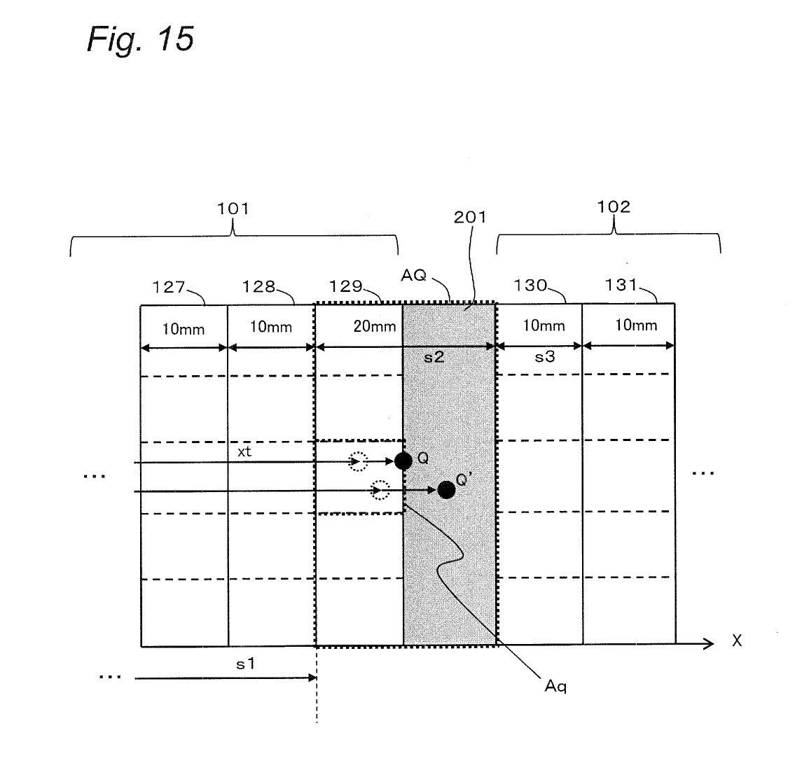

Now, the operation of calculating the touch position in the case that the joint portion 20 is touched will be described in detail. FIG. 15 is a diagram for describing a method of calculating the touch position in the case that the joint portion 20 is touched. In FIG. 15, it is assumed that the width of each of the electrode patterns of the touch panels 101 and 102 is 10 mm and the width of the joint region 201 is 10 mm as an example. In FIG. 15, a point Q on the joint region 201 between the touch panel 101 and the touch panel 102 is touched.

In this case, the position calculation circuit 13 senses that the joint region 201 is touched based on that the detection values in the right end electrode pattern 129 of the touch panel 101 and the left end electrode pattern 130 of the touch panel 102 change from the reference value larger than the detection values in any other divisions (YES in S112). The position calculation circuit 13 detects, based on the changed detection values in the touch panels 101 and 102, a division Aq that has the largest detection value among the divisions adjoining the touched joint region 201 as a division closest to the touched point Q (S114).

Next, the position calculation circuit 13 calculates the touch position of the touched point Q. Specifically, in the same manner as the process in step S126 illustrated in FIG. 12, the position calculation circuit 13 calculates the centroid of a second predetermined region around the touched joint region based on the equations (1) and (2) by using the detection values in a region of 5 rows×5 columns around the division Aq (second predetermined region) in the electrode patterns 127 to 129 of the touch panel 101 and the electrode patterns 130 and 131 of the touch panel 102. As the region of 5 rows×5 columns shown in FIG. 15, the second predetermined region is defined to include divisions adjacent to each other across the touched joint region and divisions around the divisions adjacent to each other across the touched joint region. In the centroid calculation, the coordinate xt in the case that the joint portion 20 does not exist is obtained. Specifically, the coordinate xt based on the equation (1) is calculated on the assumption that the joint region 201 and the electrode pattern 129 which includes the division Aq form one region AQ. Then, the position calculation circuit 13 executes correction calculations shown below so that the calculated values are shifted according to the dimension of the joint region 201 (S118).

A correction value Δx for correcting the calculated values according to the width of the joint region 201 is calculated according to the following equations.

Δx=(xt−s1)×α (3)

α=(s2−s3)/s3 (4)

In the equations above, the parameter s1 is a distance which is obtained as a result of subtracting the width s3 of the electrode pattern 129 from the x-coordinate of the left end of the joint region 201, and defined by the width w1 of the touch panel 101 and the width s3 of the electrode pattern. The parameter s2 is the width of a region AQ which is defined on the assumption that the electrode pattern 129 and the joint region 201 form one region. In this case, the coefficient α satisfies α=(20−10)/10=1. The position calculation circuit 13 calculates the x-coordinate by adding the correction value Δx to the calculated value xt. Specifically, the position calculation circuit 13 calculates the corrected x-coordinate xt+Δx according to the following equation.

x=xt+(xt−s1)×α (5)

If the above correction is not performed on the calculated value, even when the joint region 201 is touched, a position on the closest electrode pattern 129 is obtained as the touch position. However, with the above-described correction calculations, the position calculation circuit 13 corrects the touch position to coordinates on the joint region 201. For example, in the case that the calculated value for the point Q on the border between the joint region 201 and the electrode pattern 129 is xt=85, the x-coordinate of the touch position is corrected to 90 (=85+(85−80)×1) provided that the parameter s1=80 and the coefficient α=1. Similarly, in the case that the calculated value for the point Q′ on the joint region 201 is xt=88, the x-coordinate of the touch position is corrected to 96 (=88+(88−80)×1).

As for the joint region 204 between the touch panel 103 and the touch panel 104, the x-coordinate obtained by the centroid calculation is corrected according to the width of the joint region 204 in the same manner as in the case of the joint region 201.

As for the y-coordinate on the joint regions 202 and 203, the position calculation circuit 13 performs the same correction calculations as those for the x-coordinate on the joint regions 202 and 204. Specifically, the position calculation circuit 13 calculates the y-coordinate yt in the case that the joint portion 20 does not exist by the centroid calculation based on the equation (2). Then, the position calculation circuit 13 calculates the correction value Δy according to the following equations.

Δy=(yt−u1)×β (6)

β=(u2−u3)/u3 (7)

In the equations above, the parameter u1 is a distance which is obtained as a result of subtracting the width u3 of the drive electrode from the y-coordinate of the upper end of the joint region 202 or 203, and defined by the height h1 of the touch panel 101 and the width u3 of the electrode pattern of the drive electrode. The parameter u2 is the height of a region which is defined on the assumption that one drive electrode and the joint region 201 form one region. The coefficient β is a coefficient that depends on the height of the joint region 202 or 203. The position calculation circuit 13 calculates the corrected y-coordinate y+Δy=yt+(yt−u1)×β.

As for the joint region 205 that connects the joint regions 201 to 204 together, the position calculation circuit 13 calculates the touch position by combination of the correction calculations for the x-coordinate and the correction calculations for the y-coordinate as described above.

As described above, when any of the joint regions 201 to 205 is touched, the position calculation circuit 13 calculates the touch position in the joint region by using the detection values in the touch panels adjacent to each other across the touched joint region.

### 1-3. Effects and the Like

As described above, in the present embodiment, the liquid crystal display device includes the plurality of touch panels 101 to 104 and the position calculation circuit 13. The touch panels 101 to 104 detect a touch operation and outputs detection values. The position calculation circuit 13 calculates the touch position touched in the touch operation, based on the detection values from the touch panels 101 to 104. The touch panels 101 to 104 are joined together via the joint portion 20. In response to a touch operation of touching any of the joint regions 201 to 205 of the joint portion 20, the position calculation circuit 13 calculates the touch position in the joint regions 201 to 205 based on the detection values in the touch panels adjacent to each other across the touched joint region.

According to the above configuration, the liquid crystal display device can detect the touch position in the joint regions 201 to 205 by using the detection values in the plurality of touch panels 101 to 104 adjacent to each other across the joint portion 20.

The liquid crystal display device can calculate the touch position in the joint portion 20 that joins the touch panels 101 to 104 together. Therefore, with the simple configuration of joining the touch panels 101 to 104 together with spaces between the touch panels 101 to 104, a large display unit can be realized at low production cost. Further, since the touch panels do not overlap each other in the arrangement, the electrodes of the touch panels can be efficiently used for detecting the touch position.

### Second Embodiment

In the first embodiment, the liquid crystal display device detects the touch position in the joint portion 20 by using the detection values in the touch panels adjacent to each other across the joint portion 20. In the second embodiment, the liquid crystal display device calculates the touch position by assigning virtual detection values to the joint portion 20. The second embodiment will be described below with reference to the drawings.

### 2-1. Configuration

The configuration of the liquid crystal display device of the second embodiment is the same as that of the first embodiment. In the description below of the liquid crystal display device according to the present embodiment, the configuration and operation same as those of the liquid crystal display device according to the first embodiment is omitted as appropriate.

### 2-2. Operation

In the second embodiment, the touch position is calculated with virtual electrodes arranged virtually in the joint portion 20. A method of calculating the touch position according to the present embodiment will be described below.

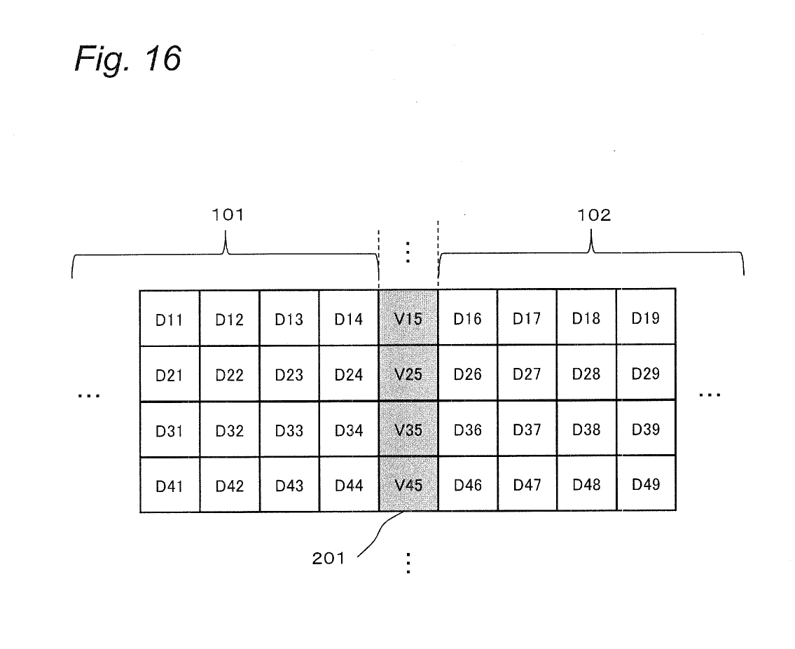

In the second embodiment, virtual detection values are assigned to the joint portion 20 to be treated as virtual electrodes. FIG. 16 is a diagram illustrating an example of arrangement of the virtual electrodes on the joint portion 20 illustrated in FIG. 10. In FIG. 16, the virtual electrodes for assigning the virtual detection values to the joint portion 20 between the touch panel 101 and the touch panel 102 are arranged on the joint portion 20. In FIG. 16, detection values D11 to D14, D21 to D24, D31 to D34, and D41 to D44 represent the detection values in the respective divisions of the electrodes of the touch panel 101. Detection values D16 to D19, D26 to D29, D36 to D39, and D46 to D49 represent the detection values in the respective divisions of the electrodes of the touch panel 102. Data values V15 to V45 represent the virtual detection values for the virtual electrodes in the joint region 201. In the present embodiment, it is assumed that the range of the detection value and the data value is 0 to 255.

In the present embodiment, as illustrated in FIG. 16, the joint region 201 has divisions which are aligned with the respective divisions on the touch panels 101 and 102, and the data values V15 to V45 are assigned to the respective divisions on the joint region 201. With this configuration, the touch position can be calculated on the assumption that the virtual electrodes are arranged on the joint region 201. A process of calculating the touch position will be described below.

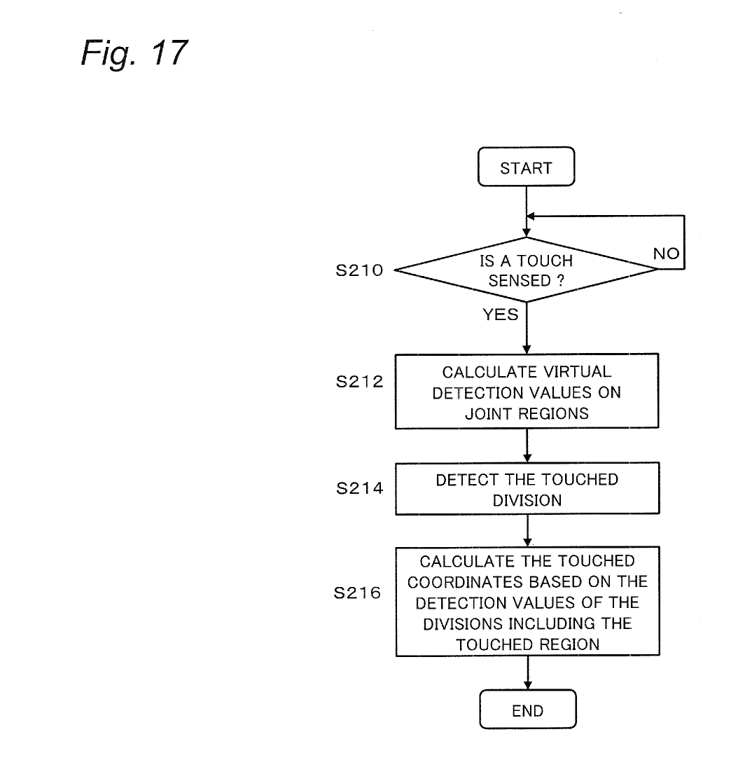

FIG. 17 is a flow chart for a process of calculating the touch position in the liquid crystal display device according to the second embodiment.

First, the position calculation circuit 13 senses whether or not a touch operation is performed (S210), in the same manner as the process in step S110 of the first embodiment. When the position calculation circuit 13 senses the touch operation (YES in S210), the position calculation circuit 13 first calculates the data values of the virtual electrodes in the joint portion 20 (5220). The position calculation circuit 13 calculates the data values of the virtual electrodes by using, for example, a mean value of the detection values in the touch panels adjoining the virtual electrodes.

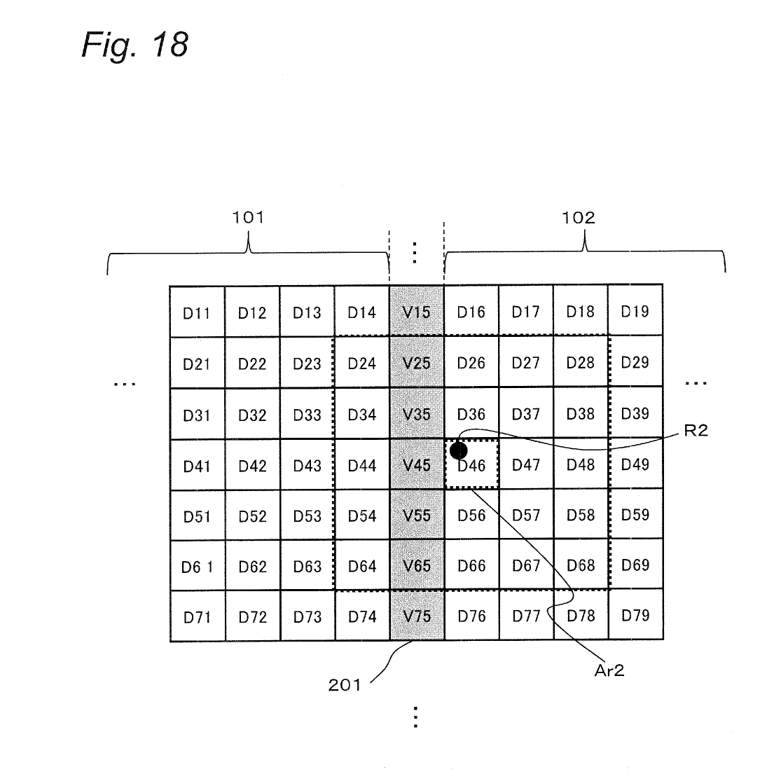

A method of calculating the data values V15 to V45 to be assigned to the virtual electrodes will be described with reference to FIG. 18. The position calculation circuit 13 calculates the data value V of the virtual electrode on the joint region 201 according to the following equation.

V={(D1×γ1)+(D2×γ2)}/2 (8)

In the equation above, the data value V is a data value for a division of a virtual electrode on the joint region 201. The detection value D1 is the detection value in the division of the electrode adjacent to the virtual electrode on the touch panel 101 which is on the left side of the joint region 201. The detection value D2 is the detection value in the division of the electrode adjacent to the virtual electrode on the touch panel 102 which is on the right side of the joint region 201. The weighting factors γ1 and γ2 are factors that depend on panel characteristics of the respective touch panels 101 and 102. The weighting factors γ1 and γ2 are, for example, values not less than 0 and not more than 2, respectively, and γ2=2−γ1. For example, in the case of the data value V15, the position calculation circuit 13 calculates V15={(D14×γ1)+(D16×γ2)}/2 based on the detection value D14 in the division located on the left of the division of the virtual electrode and the detection value D16 in the division located on the right of the division of the virtual electrode.

As for the joint region 204 illustrated in FIG. 10, the position calculation circuit 13 also calculates the data values of the virtual electrodes in the same manner as in the above-described case of the joint region 201.

In the case of the joint regions 202 and 203, the position calculation circuit 13 calculates the data value V according to the following equation.

V={(D3×γ3)+(D4×γ4)}/2 (9)

In this case, the detection value D3 is the detection value in the division of the electrode adjacent to the virtual electrode which is on the touch panel 101 or 102 located above the joint region 202 or 203. The detection value D4 is the detection value in the division of the electrode adjacent to the virtual electrode which is on the touch panel 103 or 104 located under the joint region 202 or 203. The weighting factors γ3 and γ4 are factors that depend on panel characteristics of the adjacent touch panels. The weighting factors γ3 and γ4 are, for example, values not less than 0 and not more than 2, respectively, and γ4=2−γ3.

The position calculation circuit 13 calculates the data value of the virtual electrode on the joint region 205 by using the data values of the virtual electrodes on the joint regions 201 to 204 which are adjacent to the virtual electrode on the joint region 205.

Returning to FIG. 17, the position calculation circuit 13 detects the touched division on the display surface of the display unit 1 (S214). Based on the calculated data values of the virtual electrodes and the detection values of the electrodes on the touch panels 101 to 104, the position calculation circuit 13 detects a division having the greatest changed value from the reference value as the touched division.

Next, the position calculation circuit 13 calculates the touch position based on the detection values in a predetermined region that includes the touched division (S216). This calculation process will be described with reference to FIG. 18.

A method of calculating the touch position according to the second embodiment will be described in detail with reference to FIG. 18. FIG. 18 illustrates a case where a point R2 near the joint region 201 on the touch panel 102 is touched. The position calculation circuit 13 detects a division Ar2 that includes the point R2 (S214), and calculates the centroid based on the equations (1) and (2) by using the detection values in 5 rows×5 columns around the division Ar2 (S216). The position calculation circuit 13 uses the data values V25 to V65 on the virtual electrode of the joint region 201 as one column of 5 rows×5 columns to use in the centroid calculation. The method of the centroid calculation has been described in the first embodiment.

According to the calculation of the virtual detection values of the virtual electrodes on the joint regions 201 to 205 as described above, the position calculation circuit 13 calculates the touch position in the same calculation process even when any of the touch panels 101 to 104 and the joint regions 201 to 205 is touched.

### 2-3. Effects and the Like

As described above, in the present embodiment, the position calculation circuit 13 calculates detection values of the divisions on the joint regions 201 to 205 based on the detection values in the plurality of divisions adjacent to each other across the joint regions 201 to 205, and assigns the calculated detection values to the divisions on the joint regions 201 to 205.

The position calculation circuit 13 calculates the touch position based on the detection values in a predetermined region that includes the touched division and an area around the touched division.

Accordingly, with the display surface of the display unit 1 treated continuously including the joint portion 20, the touch position in the joint portion 20 can be calculated. As a result, with the simple configuration of joining the touch panels 101 to 104 together with spaces between the touch panels 101-104, a large display unit has been realized in the liquid crystal display device even at low production cost. Further, since the touch panels are arranged so as not to overlap each other, the electrodes of the touch panels can be efficiently used.

### Other Embodiments

As described above, the first and second embodiments have been described as an exemplification of the technology disclosed in the present application. However, the technology in the present disclosure can also be applied to an embodiment in which an alteration, substitution, addition, or omission or the like has been implemented as appropriate without restriction to the first or second embodiment. Furthermore, it is also possible to combine the constituent elements described in the aforementioned the first or second embodiment to constitute a new embodiment.

Accordingly, examples of other embodiments are given hereinafter.

In each of the embodiments, although the display unit 1 includes four touch panels, the number of the touch panels is not limited thereto.

In each of the embodiments, the display unit is configured by a plurality of liquid crystal panels joined together. The display unit may be configured by one liquid crystal panel. For example, a plurality of off-cell touch panels joined together may be arranged on the display unit of one liquid crystal panel. Alternatively, electrodes for detecting electrostatic capacitance in the touch sensor may be provided on the display surface of the display unit along the joint regions having predetermined widths. Any configuration is possible as long as a plurality of touch panels having a touch sensor function are joined together via a joint region and arranged on a display surface which displays an image.

Although the liquid crystal panels are used as the display unit in each of the embodiments, the display unit may be other than the liquid crystal panels. For example, an organic EL display, an LED display, or an electronic paper display may be used as the display unit.

In each of the embodiments, the position calculation circuit 13 is configured by a semiconductor chip of each circuit mounted on a flexible wiring board, a printed circuit board, or a glass substrate. The position calculation unit may be configured by an arithmetic processing circuit such as a CPU and a memory such as a ROM and a RAM, so that the function thereof is realized by executing a predetermined program. The function of the position calculation unit may be realized by a dedicated designed electronic circuit.

In the first embodiment, the correction is performed after the centroid calculation in the calculation of the touch position. However, the correction may be performed in the centroid calculation as an arithmetic expression taking into account the widths of the joint portion and the weighting factors of the detection values.

In the first embodiment, in the processes in steps S116, S124, and S126 shown in FIG. 12, the region of the detection values used in the calculation of the touch position is not limited to 5 rows×5 columns, and may be arbitrary numbers of rows and columns such as M rows×N columns (M, N=2, 3, . . . ). Further, the region of the detection values used in the calculation of the touch position does not need to be with its center as the touched division. For example, in the case that the electrode pattern 122 illustrated in FIG. 13 is touched, the region of the electrode patterns 121 to 125 may be used in the calculation of the touch position.

Furthermore, in the first embodiment, although the position calculation circuit 13 determines whether or not a joint region is around the touched division in the process in step S122 shown in FIG. 12, the position calculation circuit 13 may determine whether or not the touched division adjoins a joint region. When the touched division adjoins a joint region, the position calculation circuit 13 may calculate the touch position by using the detection values in the touch panels adjacent to each other across the joint region, or otherwise, the position calculation circuit 13 may use the detection values of the single touch panel. Alternatively, the position calculation circuit 13 may determine whether or not the touched division adjoins a joint region from one specific side.

In the first embodiment, the coefficients α and β are defined as the coefficients depending on the width and the height of the joint region. However, the coefficients α and β may be defined by other methods. The coefficients α and β may be adjusted in accordance with the dimensions or materials of the joint region or the positional relationship between the touch position and the joint region. For example, in the joint region 201 or the joint region 204, different coefficients α and β may be used.

This application claims priority of Japanese Patent Application No.: 2014/061333 filed on Mar. 25, 2014, and Japanese Patent Application No.: 2014/182431 filed on Sep. 8, 2014, the contents of which are incorporated herein by reference.

### INDUSTRIAL APPLICABILITY

The present disclosure may be applied to a large display device made of a plurality of touch panels each having a capacitive coupling type input function such as an electronic blackboard.

What is claimed is:

1. An input device comprising:
a plurality of touch panels each configured to detect a touch operation and output detection values; and
a position calculation unit configured to calculate a touch position touched in the touch operation, based on the detection values from the touch panels, wherein
the touch panels are joined together via a joint portion;
the position calculation unit
calculates, in response to a touch operation of touching a joint region on the joint portion, the touch position in the joint region based on the detection values in the touch panels adjacent to each other across the touched joint region.

2. The input device according to claim 1, wherein
each of the touch panels is provided with a detection region to detect the touch operation, and the detection region is divided into a plurality of divisions, and
the position calculation unit
calculates the touch position based on the detection values detected in a first predetermined region including the touched division and divisions around the touched division.

3. The input device according to claim 2, wherein
the position calculation unit senses whether the joint region is touched or not based on the detection values in divisions adjacent to each other across the joint region, and
when the position calculation unit senses that the joint region is touched,
the position calculation unit
calculates the touch position based on the detection values detected in a second predetermined region including divisions adjacent to each other across the touched joint region and divisions around the divisions adjacent to each other across the touched joint region.

4. The input device according to claim 3, wherein
when the position calculation unit does not sense that the joint region is touched,
the position calculation unit calculates the touch position by calculating a centroid of the first predetermine region based on detection values detected in the first predetermine region; and
when the position calculation unit senses that the joint region is touched,
the position calculation unit calculates the touch position by calculating a centroid of the second predetermine region based on detection values detected in the second predetermine region, and correcting the calculated value of the centroid of the second predetermine region according to dimensions of the touched joint region.

5. The input device according to claim 2, wherein
the position calculation unit
calculates detection values of divisions on the joint regions based on detection values in a plurality of divisions adjacent to each other across each of the joint regions, and
assigns the calculated detection values to the divisions on the joint regions.

6. The input device according to claim 1, wherein
the touch panel
comprises a plurality of first and second electrodes arranged to cross each other, and
detects the detection value by detecting variation of electrostatic capacitance between the first and second electrodes.

7. A display device comprising:
the input device according to claim 1; and
a display unit having a display surface configured to display an image.
